(19) United States
(12) Patent Application Publication
(10) Pub. No.: US 2025/0172795 A1
(43) Pub. Date: May 29, 2025

(54) ENDOSCOPE THAT HAS OBJECTIVE OPTICAL SYSTEM FOR ENDOSCOPE

(71) Applicant: OLYMPUS MEDICAL SYSTEMS CORP., Tokyo (JP)

(72) Inventor: Hirohiko KIMATA, Hachioji-shi (JP)

(73) Assignee: OLYMPUS MEDICAL SYSTEMS CORP., Tokyo (JP)

(21) Appl. No.: 18/960,185

(22) Filed: Nov. 26, 2024

Related U.S. Application Data
(60) Provisional application No. 63/603,852, filed on Nov. 29, 2023.

(51) Int. Cl. G02B 23/24; G02B 9/14

(52) U.S. Cl. CPC G02B 23/243; G02B 9/14

(57) ABSTRACT

An endoscope of the present invention has an objective optical system for an endoscope and an imaging element. The objective optical system for an endoscope consists of a first lens group with a positive refractive power, a second lens group with a negative refractive power, and a third lens group with a positive refractive power. The first lens group consists of two negative lenses and two cemented lenses. The negative lens disposed on the object side has a flat surface on the object side, and an image side surface of the negative lens is a concave surface. An image side surface of the negative lens disposed on the image side is a concave surface that faces the image side. The cemented lens consists of a negative lens and a positive lens and has a cemented surface forming a convex curved surface protruding toward the object side.

### CROSS-REFERENCE TO RELATED APPLICATION

This application is related to and claims priority under 35 U.S.C. § 119 to U.S. provisional patent application 63/603,852, filed Nov. 29, 2023 the entire contents of which are incorporated herein by reference.

### FIELD

Embodiments described herein relate generally to an endoscope that has an objective optical system for endoscope.

### BACKGROUND OF THE INVENTION

An endoscope is used by a user such as a technician or a doctor to perform examination, diagnosis, treatment, and procedures while directly viewing an image of a diseased area in a subject. Since an insertion section of an endoscope is inserted from outside the body of a subject into the body, it is preferable that the total length of an objective optical system for an endoscope provided in the insertion section be short and the diameter of the objective optical system for an endoscope be small. In order to expand the scope of application of an endoscope for examination, diagnosis, treatment, and procedures, it is preferable that normal observation and close-up magnified observation be able to be carried out in accordance with the conditions within an observation range. For example, each document of Japanese Patent No. 5802847, Japanese Patent No. 5580953, PCT International Publication No. WO 2020/174561 and Japanese Patent No. 6857572 discloses an objective optical system for an endoscope that includes lens groups of a first lens group to a third lens group.

In the objective optical system for an endoscope disclosed in each of Japanese Patent No. 5802847 and Japanese Patent No. 5580953, the reduction in total length and the elimination of coma aberration, axial chromatic aberration, and lateral chromatic aberration are not sufficient. In the objective optical system for an endoscope disclosed in each of PCT International Publication No. WO 2020/174561 and Japanese Patent No. 6857572, the elimination of coma aberration, axial chromatic aberration, and lateral chromatic aberration is not sufficient. Furthermore, if the F-number of the objective optical system for an endoscope is large, when an imaging element with a small pixel pitch is used, degradation of optical performance caused by diffraction occurring due to a plurality of pixels becomes apparent. Therefore, by reducing the F-number of the objective optical system for an endoscope, the influence of the diffraction can be avoided. The objective optical system for an endoscope disclosed in each of Japanese Patent No. 5802847 and Japanese Patent No. 5580953 is intended to be small in size, but has a large F-number. As described above, in recent years, the reduction of the pixel pitch has been intended according to the miniaturization and increased resolution of the imaging element, and in this situation, the degradation of the optical performance caused by the influence of the diffraction at the imaging element cannot be ignored in the endoscope disclosed in each of Japanese Patent No. 5802847 and Japanese Patent No. 5580953.

### SUMMARY OF THE INVENTION

An endoscope that has an objective optical system for an endoscope of the present invention has an objective optical system for an endoscope and an imaging element disposed on an image side of the objective optical system for an endoscope.

The objective optical system for an endoscope consists of a first lens group with a positive refractive power, a second lens group with a negative refractive power, and a third lens group with a positive refractive power, which are disposed in order from an object side to the image side. During focusing and magnification changing operations, the second lens group moves along an optical axis. The first lens group includes a negative lens that has a flat surface on the object side and of which an image side surface is a concave surface that faces the image side, a negative lens of which an image side surface is a concave surface that faces the image side, a cemented lens that consists of, in order from the object side, a negative lens and a positive lens, and has a cemented surface forming a convex curved surface protruding toward the object side, and a cemented lens that consists of, in order from the object side, a negative lens and a positive lens, and has a cemented surface forming a convex curved surface protruding toward the object side, which are disposed in order from the object side to the image side.

### BRIEF DESCRIPTION OF THE DRAWINGS

FIG. 1 is a cross-sectional view of an objective optical system for an endoscope according to Example 1.

FIG. 2 is a cross-sectional view of an objective optical system for an endoscope according to Example 2.

FIG. 3 is a cross-sectional view of an objective optical system for an endoscope according to Example 3.

FIG. 4 is a cross-sectional view of an objective optical system for an endoscope according to Example 4.

FIG. 5 is a cross-sectional view of an objective optical system for an endoscope according to Example 5.

FIG. 6 is an aberration diagram the objective optical system for an endoscope according to Example 1.

FIG. 7 is an aberration diagram the objective optical system for an endoscope according to Example 2.

FIG. 8 is an aberration diagram the objective optical system for an endoscope according to Example 3.

FIG. 9 is an aberration diagram the objective optical system for an endoscope according to Example 4.

FIG. 10 is an aberration diagram the objective optical system for an endoscope according to Example 5.

FIG. 11 is a schematic diagram of an endoscope according to an embodiment of the present invention and an imaging device to which the endoscope is connected.

### DETAILED DESCRIPTION OF THE PREFERRED EMBODIMENT

Hereinafter, an embodiment of an endoscope that has an objective optical system for an endoscope according to an aspect of the present invention will be described with reference to the drawings. Specific examples will be given when explaining the effects of the present embodiment. The embodiment which will be shown is a part of the aspect included in the present invention, as well as the examples which will be described below. There are a plurality of modification examples in the embodiment which will be shown. The present invention is not limited to the embodiment which will be shown.

In the following description, the objective optical system for an endoscope may be simply referred to as an objective optical system. The endoscope that has an objective optical system for an endoscope may simply be referred to as an endoscope. The endoscope of the present embodiment is used to observe an object to be observed such as a diseased area in a subject. An example of the configuration of the endoscope according to the present embodiment will be described below. An objective optical system is provided at the distal end portion of the endoscope of the present embodiment.

The objective optical system provided in the endoscope of the present embodiment can automatically focus on each of both a near object point that is relatively close to the optical system and a far object point that is farther away than the near object point. By focusing on the near object point, an object to be observed can be observed at a magnification greater than a predetermined magnification. In addition, by focusing on the far object point, the object to be observed can be observed at a predetermined magnification. In the following, observation performed when the objective optical system focuses on the near object point may be referred to as magnified observation, and observation performed when the objective optical system focuses on the far object point may be referred to as normal observation.

The objective optical system of the present embodiment consists of a first lens group having a positive refractive power, a second lens group having a negative refractive power, and a third lens group having a positive refractive power, which are disposed in order from an object side to an image side. In the objective optical system of the present embodiment, during focusing and magnification changing operations, the second lens group moves along an optical axis. The second lens group moves from the object side to the image side along the optical axis, and thus focusing from a far object point to a near object point is performed in the objective optical system of the present embodiment. During focusing and magnification changing operations in the objective optical system of the present embodiment, only the second lens group moves, and the first lens group and the third lens group are fixed. In the objective optical system of the present embodiment, a plurality of lens groups from the first lens group to the third lens group are provided, and thus the diameter of the entire system in a plane perpendicular to the optical axis is reduced, making it smaller as intended.

In the objective optical system of the present embodiment, the first lens group consists of two negative lenses and two cemented lenses, which are disposed in order from the object side to the image side. The object side surface of the negative lens disposed on the object side out of the two negative lenses in the first lens group is, for example, a flat surface and is perpendicular to the optical axis. The image side surface of the negative lens disposed on the object side out of the two negative lenses in the first lens group is a concave surface that is recessed toward the object side. The object side surface of the negative lens disposed on the image side out of the two negative lenses in the first lens group is not specified. The object side surface is, for example, a flat surface and is perpendicular to the optical axis. The image side surface of the negative lens disposed on the image side out of the two negative lenses in the first lens group is a concave surface that is recessed toward the object side. As described above, in the first lens group, in order from the object side, the negative lens that has a flat surface on the object side and has a concave surface on the image side, and the negative lens that has the concave surface on the image side are disposed side by side on the optical axis, and thus a negative refractive power is shared by the two negative lenses and the amount of various aberrations that occur in the first lens group and the objective optical system is reduced.

In the first lens group of the objective optical system of the present embodiment, the two cemented lenses are disposed side by side on the optical axis on the image side of the two negative lenses, thereby suppressing chromatic aberration in the first lens group and the objective optical system. In the first lens group, each cemented lens of the two cemented lenses has a negative lens and a positive lens, which are disposed from the object side to the image side. A cemented surface between the negative lens and the positive lens in each cemented lens is a convex curved surface that protrudes toward the object side. For this reason, the rear side principal point of the entire first lens group is formed on the image side. As a result, the distance of the first lens group to the second lens group on the optical axis is easily ensured, the spacing between the first lens group and the second lens group on the optical axis is ensured, and the amount of movement of the second lens group on the optical axis is ensured. In the present specification, the term “spacing” refers to the air spacing, and means the separation distance in air between one surface and the other surface in a direction parallel to the optical axis. Unless otherwise specified, the spacing and distance refer to the distance on the optical axis between one surface and the other surface of an objective optical system or an optical member.

The endoscope of the present embodiment has the objective optical system and an imaging element disposed on the image side of the objective optical system. In general, when the F-number of the objective optical system of the endoscope that has the objective optical system for an endoscope is reduced, the influence of diffraction caused by a plurality of pixels of the imaging element is easily reduced, but the observable depth, that is, the depth of focus, becomes narrow, and the accuracy required for the position on the optical axis of the second lens group becomes strict. In the objective optical system of the present embodiment, by providing the above-mentioned configuration, a larger amount of movement of the second lens group is ensured. For this reason, the movement sensitivity of the second lens group in the objective optical system of the present embodiment with respect to a focus is reduced, the accuracy required for the position of the second lens group is relaxed, and the easiness of operation of the objective optical system is increased.

The objective optical system of the present embodiment satisfies the following conditional expression (1).

$$Fno < 4. \qquad ( 1 )$$

In conditional expression (1), Fno represents an F-number of the objective optical system of the present embodiment when focusing on a far object distance.

Conditional expression (1) relates to an appropriate range of the F-number of the objective optical system in order to minimize the influence of the diffraction caused by the plurality of pixels of the imaging element in the endoscope of the present embodiment.

When conditional expression (1) is satisfied, the influence of the diffraction caused by the plurality of pixels of the imaging element disposed on the image side of the third lens group of the endoscope of the present embodiment is appropriately reduced, and a larger amount of movement of the second lens group can be ensured. In conditional expression (1), if Fno exceeds the upper limit value, the influence of the diffraction caused by the plurality of pixels of the imaging element in the endoscope of the present embodiment becomes excessively large, the amount of movement of the second lens group is excessively reduced, and degradation of the optical performance of the endoscope becomes apparent. When it is assumed that the pixel pitch of the imaging element of the endoscope of the present embodiment is P and the central wavelength of the light incident on the objective optical system of the present embodiment is λ, it is preferable that the F-number of the objective optical system of the present embodiment be smaller than (2×P/1.22/λ).

A cover glass is disposed on the most object side of the imaging element of the endoscope of the present embodiment. In the imaging element, a photo detecting element is disposed on the image side of the cover glass. The image surface of the objective optical system of the present embodiment and the focusing position of a light beam in the objective optical system of the present embodiment are located on the surface of the incidence side of the photo detecting element, correspond to the interface between the image side surface of the cover glass and the object side surface of the photo detecting element, and are on the image side surface of the cover glass.

The third lens group has a lens having a positive refractive power, that is, a positive lens, cemented to the object side of the cover glass. As described above, when the F-number of the objective optical system is reduced, the influence of the diffraction caused by the plurality of pixels of the photo detecting element is easily reduced, but the observation depth becomes excessively narrow. In a case in which the focusing operation and the focus adjustment are performed using such an objective optical system, it is difficult to stably obtain favorable optical performance. In this case, even if there are two objective optical systems having the same configuration, a phenomenon in which the observation depths of the two objective optical systems differ from each other occurs due to variations in the manufacturing of the objective optical systems. In this time, the image observed at the near object point or the image observed at the far object point may be blurred. Hereinafter, the near object point may be referred to as a near point, and the far object point may be referred to as a far point. In particular, in an objective optical system that performs focusing and magnification changing, the distance between the objective optical system and the object during the magnified observation is short and the observation depth is narrow, and thus the focus adjustment sensitivity is excessively high, making it difficult for the user of the endoscope to focus on the object to be observed, such as a diseased area.

In the objective optical system of the present embodiment, the positive lens having a positive refractive power in the third lens group is cemented to the object side of the cover glass. That is, the third lens group has the positive lens on the most image side, and the positive lens disposed on the most image side in the third lens group is cemented to the cover glass of the imaging element. As a result, in the objective optical system of the present embodiment, the observation depth during the magnified observation is ensured, making it easy for the user of the endoscope to focus on the object to be observed, thereby resolving the problems of the related art.

The objective optical system of the present embodiment satisfies the following conditional expression (2).

$$1. 0 < flr / fc 12 < 5. \qquad ( 2 )$$

In conditional expression (2), flr represents a focal length of the positive lens cemented to the incidence side of the cover glass, and fc12 represents a composite focal length of the two cemented lenses in the first lens group.

Conditional expression (2) relates to the ratio between the composite focal length of the two cemented lenses in the first lens group and the focal length of a single lens with a positive refractive power in the third lens group cemented to the cover glass. When conditional expression (2) is satisfied, an appropriate observation depth is ensured even during the magnified observation. In the objective optical system of the present embodiment, in conditional expression (2), when (flr/fc12) exceeds the upper limit value, the effect of the lens with a positive refractive power in the objective optical system of the present embodiment being cemented to the imaging element is not exerted, and the focus adjustment sensitivity does not decrease significantly, which is not preferable. In conditional expression (2), when (flr/fc12) falls below the lower limit value, the focus adjustment sensitivity of the objective optical system of the present embodiment decreases, but the light beam emitted from the second lens group at an extremely large divergence angle has to be refracted toward the image surface, and the amount of aberration that occurs in the third lens group becomes excessively large, making it difficult to ensure various performances, including the optical performance, of the objective optical system and the endoscope.

The objective optical system of the present embodiment satisfies the following conditional expression (3).

$$1. < fc 1 / fc 2 < 3. \qquad ( 3 )$$

In expression (3), fc1 represents a focal length of the cemented lens disposed on the object side out of the two cemented lenses in the first lens group. fc2 represents a focal length of the cemented lens disposed on the image side out of the two cemented lenses in the first lens group.

Conditional expression (3) relates to the ratio between the focal length of the cemented lens disposed on the object side of the first lens group and the focal length of the cemented lens disposed on the image side of the first lens group.

When conditional expression (3) is satisfied, the lateral chromatic aberration of the F-line (light blue, 486.1 [nm]) in the objective optical system of the present embodiment is favorably corrected. In conditional expression (3), when (fc1/fc2) exceeds the upper limit value, the lateral chromatic aberration of the F-line in the periphery of the objective optical system of the present embodiment, that is, in a region at least outside the center in a radial direction centered on the optical axis, is likely to fall toward the over side or the under side, making it difficult to ensure the optical performance of the objective optical system. In conditional expression (3), even in a case in which (fc1/fc2) falls below the lower limit value, the lateral chromatic aberration of the F-line in the periphery of the objective optical system of the present embodiment is likely to fall toward the over side or the under side, making it difficult to ensure the optical performance of the objective optical system.

The objective optical system of the present embodiment satisfies the following conditional expressions (4) and (5).

$$1. < fc 1 n / fc 2 n < 3. \qquad ( 4 )$$

In conditional expression (4), fc1n represents a focal length of the negative lens of the cemented lens disposed on the object side out of the two cemented lenses in the first lens group. fc2n represents a focal length of the negative lens of the cemented lens disposed on the image side out of the two cemented lenses in the first lens group.

Conditional expression (4) relates to the ratio between the focal length of the negative lens of the cemented lens disposed on the object side in the first lens group and the focal length of the negative lens of the cemented lens disposed on the image side in the first lens group.

$$1. < fc 1 p / fc 2 p < 3. \qquad ( 5 )$$

In conditional expression (5), fc1p represents a focal length of the positive lens of the cemented lens disposed on the object side out of the two cemented lenses in the first lens group. fc2p represents a focal length of the positive lens of the cemented lens disposed on the image side out of the two cemented lenses in the first lens group.

Conditional expression (5) relates to the ratio between the focal length of the positive lens of the cemented lens disposed on the object side in the first lens group and the focal length of the positive lens of the cemented lens disposed on the image side in the first lens group.

When conditional expression (4) and conditional expression (5) are satisfied, the lateral chromatic aberration of the F-line in the objective optical system of the present embodiment is favorably corrected. Even in either case of a case in which in which (fc1n/fc2n) exceeds the upper limit value in conditional expression (4), or a case in which (fc1p/fc2p) exceeds the upper limit value in conditional expression (5), the lateral chromatic aberration of the F-line in the periphery of the objective optical system of the present embodiment is likely to fall toward the over side or the under side, making it difficult to ensure the optical performance of the objective optical system. Even in either case of a case in which in which (fc1n/fc2n) falls below the lower limit value in conditional expression (4), or a case in which (fc1p/fc2p) falls below the upper limit value in conditional expression (5), the lateral chromatic aberration of the F-line in the periphery of the objective optical system of the present embodiment is likely to fall toward the over side or the under side, making it difficult to ensure the optical performance of the objective optical system.

The objective optical system of the present embodiment satisfies the following conditional expression (6).

$$- 5. < fc 1 n / fc 12 < - 1. \qquad ( 6 )$$

In conditional expression (6), fc1n represents a focal length of the negative lens of the cemented lens disposed on the object side out of the two cemented lenses in the first lens group, and fc12 represents a composite focal length of the two cemented lenses in the first lens group.

Conditional expression (6) relates to the ratio between the composite focal length of the two cemented lenses in the first lens group and the focal length of the negative lens of the cemented lens disposed on the object side in the first lens group. When conditional expression (6) is satisfied, the lateral chromatic aberration of the F-line in the objective optical system of the present embodiment is favorably corrected. In conditional expression (6), when (fc1n/fc12) exceeds the upper limit value, the lateral chromatic aberration of the F-line in the periphery of the objective optical system of the present embodiment falls toward the over side, making it difficult to ensure various performances in the periphery. In conditional expression (6), when (fc1n/fc12) falls below the lower limit value, the lateral chromatic aberration of the F-line in the periphery of the objective optical system of the present embodiment falls toward the under side, making it difficult to ensure various performances in the periphery.

The objective optical system of the present embodiment has an aperture stop. The aperture stop is disposed on the most image side of the first lens group and restricts axial light flux. In the objective optical system of the present embodiment, during focusing and magnification changing operations, the position of the first lens group is fixed. The first lens group is supported by a support member such as a lens barrel or a holder that supports the first lens group from the outside in a radial direction centered on the optical axis and is fixed on the optical axis by a positioning member such as a protrusion that protrudes from the inner circumferential surface of the support member toward the optical axis.

The objective optical system of the present embodiment satisfies the following conditional expression (7).

$$1. < d 1 a / d c 1 a < 3. \qquad ( 7 )$$

In conditional expression (7), d1a represents a distance from the most object side surface of the first lens group to the aperture stop, and dc1a represents a distance from an object side surface of the cemented lens disposed on the object side out of the two cemented lenses in the first lens group to the aperture stop. Conditional expression (7) relates to the ratio between the distance from an object side surface of the cemented lens disposed on the object side out of the two cemented lenses in the first lens group to the aperture stop and the distance from the most object side surface of the first lens group to the aperture stop.

Since the objective optical system of the present embodiment has the aperture stop as described above and conditional expression (7) is satisfied, the optical path length of the objective optical system of the present embodiment is appropriately ensured, the lateral chromatic aberration is favorably eliminated, and miniaturization is achieved. In conditional expression (7), when (d1a/dc1a) exceeds the upper limit value, the total length of the first lens group becomes long, and the negative lens disposed on the most object side in the first lens group is disposed at a position farthest from the aperture stop. As a result, the outer diameter of the objective optical system of the present embodiment is excessively large, and the outer diameter of the distal end portion of the endoscope in which the objective optical system of the present embodiment is provided is excessively large.

The objective optical system of the present embodiment satisfies the following conditional expression (8).

$$2. < fc 12 / fw < 5. \qquad ( 8 )$$

In conditional expression (8), fc12 represents a composite focal length of the two cemented lenses in the first lens group, and fw represents a focal length of the entire objective optical system of the present embodiment when focusing on a far object point.

The conditional expression (8) relates to the ratio between the composite focal length of the two cemented lenses in the first lens group and the focal length of the entire objective optical system of the present embodiment when focusing on the far object point.

When conditional expression (8) is satisfied, the lateral chromatic aberration of the F-line in the objective optical system of the present embodiment is favorably corrected. In conditional expression (8), when (fc12/fw) exceeds the upper limit value, the lateral chromatic aberration of the F-line in the periphery of the objective optical system of the present embodiment falls toward the over side, making it difficult to ensure various performances in the periphery. In conditional expression (8), when (fc12/fw) falls below the lower limit value, the lateral chromatic aberration of the F-line in the periphery of the objective optical system of the present embodiment falls toward the under side, making it difficult to ensure various performances in the periphery.

The objective optical system of the present embodiment satisfies the following conditional expression (9).

$$0.5 < fc 12 / f 1 < 2. \qquad ( 9 )$$

In conditional expression (9), fc12 represents a composite focal length of the two cemented lenses in the first lens group, and f1 represents a focal length of the first lens group.

Conditional expression (9) relates to the ratio between the composite focal length of the two cemented lenses in the first lens group and the focal length of the first lens group.

When conditional expression (9) is satisfied, the lateral chromatic aberration of the F-line in the objective optical system of the present embodiment is favorably corrected. In conditional expression (9), when (fc12/f1) exceeds the upper limit value, the lateral chromatic aberration of the F-line in the periphery of the objective optical system of the present embodiment falls toward the over side, making it difficult to ensure various performances in the periphery. In conditional expression (9), when (fc12/f1) falls below the lower limit value, the lateral chromatic aberration of the F-line in the periphery of the objective optical system of the present embodiment falls toward the under side, making it difficult to ensure various performances in the periphery.

In the objective optical system of the present embodiment, the second lens group consists of a cemented lens of a negative lens and a positive lens, which are disposed in order from the object side to the image side. That is, the second lens group is constituted by the cemented lens having the negative lens disposed on the object side and the positive lens cemented to the image side of the negative lens. The image side surface of the cemented lens in the second lens group is concave surface that faces the image side.

In the objective optical system of the present embodiment, when the second lens group is constituted by a single lens, the amount of chromatic aberration that occurs during the magnified observation increases. On the other hand, if the number of lenses constituting the second lens group increases, the total length of the objective optical system of the present embodiment increases excessively. For these reasons, it is preferable that the second lens group be constituted by one cemented lens. As a result, the amount of chromatic aberration that occurs in the objective optical system of the present embodiment at least during the magnified observation is reduced, and the chromatic aberration is favorably corrected and the total length of the objective optical system is appropriately reduced, and thus miniaturization of the objective optical system is achieved.

In the second lens group of the objective optical system of the present embodiment, the most image side surface is a concave surface that faces the image side. As a result, the light beam emitted from the second lens group forms a relatively large angle with respect to the optical axis, and divergence light of which a divergence angle, that is, a beam spread angle, is large is emitted toward the third lens group. As a result, a magnification changing ratio in the objective optical system of the present embodiment is ensured.

The objective optical system of the present embodiment satisfies the following conditional expression (10).

$$- 4.0 < f 2 / fc 12 < - 1. \qquad ( 10 )$$

In conditional expression (10), f2 represents a focal length of the second lens group, and fc12 represents a composite focal length of the two cemented lenses in the first lens group.

Conditional expression (10) relates to the ratio between the composite focal length of the two cemented lenses in the first lens group and the focal length of the second lens group.

When conditional expression (10) is satisfied, the lateral chromatic aberration of the F-line in the objective optical system of the present embodiment is favorably corrected. In conditional expression (10), when (f2/fc12) exceeds the upper limit value, the lateral chromatic aberration of the F-line in the periphery of the objective optical system of the present embodiment falls toward the over side, making it difficult to ensure various performances in the periphery. In conditional expression (10), when (f2/fc12) falls below the lower limit value, the lateral chromatic aberration of the F-line in the periphery of the objective optical system of the present embodiment falls toward the under side, making it difficult to ensure various performances in the periphery.

The imaging element of the endoscope of the present embodiment has the cover glass disposed on the incidence side as described above. The third lens group of the objective optical system of the present embodiment includes a positive lens cemented to the object side of the cover glass and one biconvex single lens. The third lens group does not include any single lens having a positive refractive power other than the two lenses, that is, the positive lens disposed on the most image side and the biconvex single lens disposed on the most object side.

As described above, in order to ensure the magnification changing ratio, divergence light emitted from the second lens group at a large divergence angle is incident on the third lens group of the objective optical system of the present embodiment. Therefore, the third lens group is required to have a strong positive refractive power in order to refract the divergence light that is incident on the third lens group such that the divergence light approaches the optical axis as the divergence light approaches the image surface. If, in order to strengthen the positive refractive power of the third lens group, a large number, at least two or more, of single lenses having a positive refractive power are included in the third lens group, and these single lenses share a positive refractive power required for the third lens group as a whole, due to the trade-off between improving and ensuring the positive refractive power and reducing the chromatic aberration, elimination of the chromatic aberration is insufficient. Therefore, it is preferable that the third lens group of the objective optical system of the present embodiment have only one biconvex single lens in addition to the positive lens cemented to the object side surface of the cover glass of the imaging element or the object side surface of the photo detecting element in a case in which the cover glass is omitted.

The objective optical system of the present embodiment satisfies the following conditional expression (11).

$$0.5 < flp / fc 12 < 3. \qquad ( 11 )$$

In conditional expression (11), flp represents a focal length of the biconvex single lens in the third lens group, and fc12 represents a composite focal length of the two cemented lenses in the first lens group.

Conditional expression (11) relates to the ratio between the composite focal length of the two cemented lenses in the first lens group and the focal length of the biconvex single lens in the third lens group.

When conditional expression (11) is satisfied, the lateral chromatic aberration of the F-line in the objective optical system of the present embodiment is favorably corrected. In conditional expression (11), when (flp/fc12) exceeds the upper limit value, the lateral chromatic aberration of the F-line in the periphery of the objective optical system of the present embodiment is likely to fall toward the over side or the under side, making it difficult to ensure the optical performance of the objective optical system. In conditional expression (11), even in a case in which (flp/fc12) falls below the lower limit value, the lateral chromatic aberration of the F-line in the periphery of the objective optical system of the present embodiment is likely to fall toward the over side or the under side, making it difficult to ensure the optical performance of the objective optical system.

Third lens group of the objective optical system of the present embodiment consists of, for example, a biconvex single lens, a cemented lens, and a positive lens, which are disposed from the object side to the image side. The cemented lens in the third lens group is constituted by a biconvex lens having a positive refractive power disposed on the object side and a plano-concave lens having a negative refractive power cemented to the image side of the biconvex lens. The above-mentioned configuration is one example of the configuration of the third lens group, and due to the above-mentioned configuration, a sufficient positive refractive power is realized in the third lens group and the chromatic aberration is favorably corrected.

According to the endoscope of the present embodiment described above, the magnified observation according to the distance to an object to be observed is possible. In the endoscope that has the objective optical system of the present embodiment, the total length of the objective optical system is appropriately reduced, and the size in the radial direction centered on the optical axis of the objective optical system is appropriately reduced, and thus miniaturization is achieved. In the objective optical system of the present embodiment, the focal depth and the viewing angle are sufficiently ensured, and various aberrations are favorably corrected. For this reason, the user of the endoscope of the present embodiment is not required to have excessively high operating accuracy, and the user can easily observe and diagnose the diseased area using the endoscope of the present embodiment. The endoscope of the present embodiment has an objective optical system in which magnification changing is possible and which has high performance and is miniaturized. For this reason, the user can smoothly transport the insertion section of the endoscope of the present embodiment to the object to be observed and can perform normal observation and close-up magnified observation with high accuracy through simple operation.

It is preferable that the configurations and the relative arrangements of the various lenses and conditional expressions (1) to (11) described above be mutually and simultaneously satisfied. Regarding conditional expressions (1) to (11), at least one of the lower limit value and the upper limit value may be modified as follows. Such modifications further enhance the effect of satisfying each conditional expression.

Regarding conditional expression (1), it is more preferable to set the upper limit value to 3.8.

Regarding conditional expression (2), the modifications are as follows. The lower limit value is more preferably 2.5, and even more preferably 3.0. The upper limit value is more preferably 4.0, and even more preferably 3.5.

Regarding conditional expression (3), the modifications are as follows. The lower limit value is more preferably 1.1, and even more preferably 1.2. The upper limit value is more preferably 2.7, and even more preferably 2.5.

Regarding conditional expression (4), the modifications are as follows. The lower limit value is more preferably 1.3, and even more preferably 1.5. The upper limit value is more preferably 2.5, and even more preferably 2.3.

Regarding conditional expression (5), the modifications are as follows. The lower limit value is more preferably 1.2, and even more preferably 1.4. The upper limit value is more preferably 2.0, and even more preferably 1.8.

Regarding conditional expression (6), the modifications are as follows. The lower limit value is more preferably −4.0, and even more preferably −3.2. The upper limit value is more preferably −1.2, and even more preferably −1.4.

Regarding conditional expression (7), the modifications are as follows. The lower limit value is more preferably 1.5, and even more preferably 1.7. The upper limit value is more preferably 2.0, and even more preferably 1.8.

Regarding conditional expression (8), the modifications are as follows. The lower limit value is more preferably 2.5, and even more preferably 2.8. The upper limit value is more preferably 4.0, and even more preferably 3.6.

Regarding conditional expression (9), the modifications are as follows. The lower limit value is more preferably 0.8, and even more preferably 1.1. The upper limit value is more preferably 1.7, and even more preferably 1.5.

Regarding conditional expression (10), the modifications are as follows. The lower limit value is more preferably −3.0, and even more preferably −2.6. The upper limit value is more preferably −1.5, and even more preferably −1.9.

Regarding conditional expression (11), the modifications are as follows. The lower limit value is more preferably 1.4, and even more preferably 1.95. The upper limit value is more preferably 4.8, and even more preferably 4.5.

Next, examples of the objective optical system according to the present embodiment will be described. The present invention is not limited to the following examples.

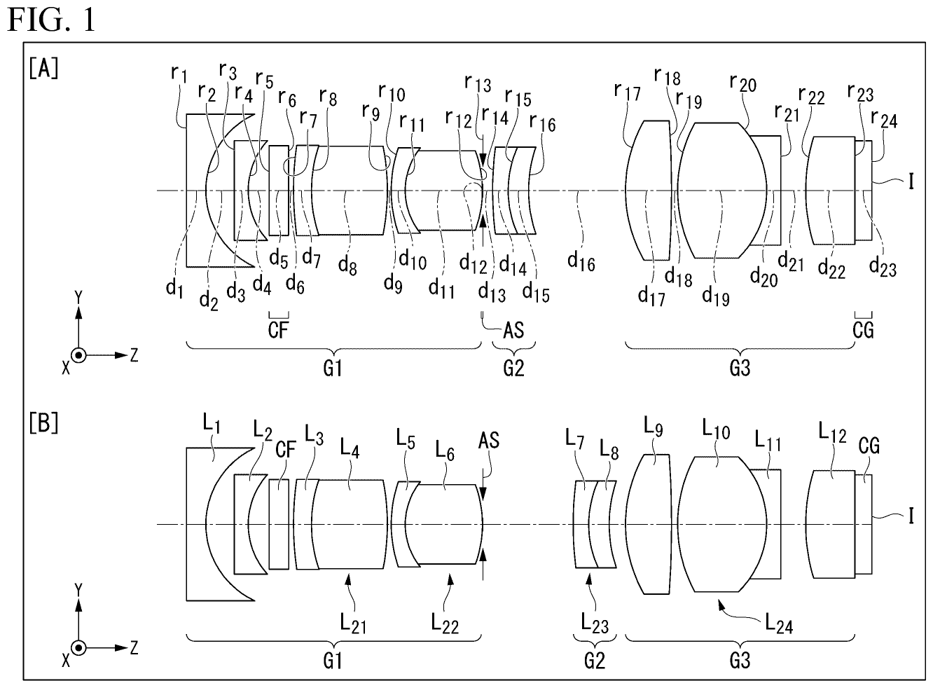

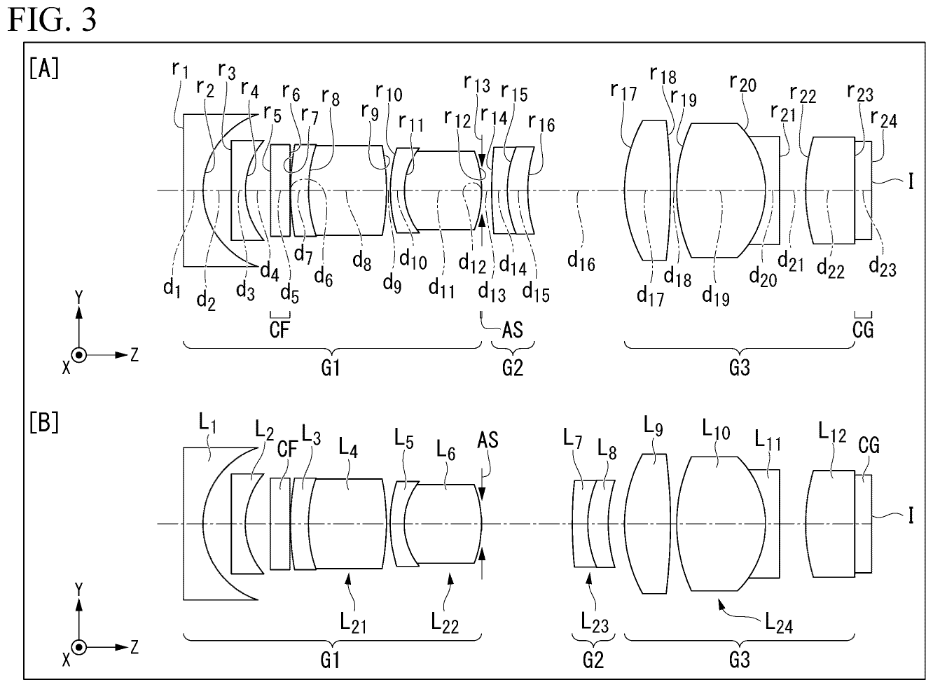

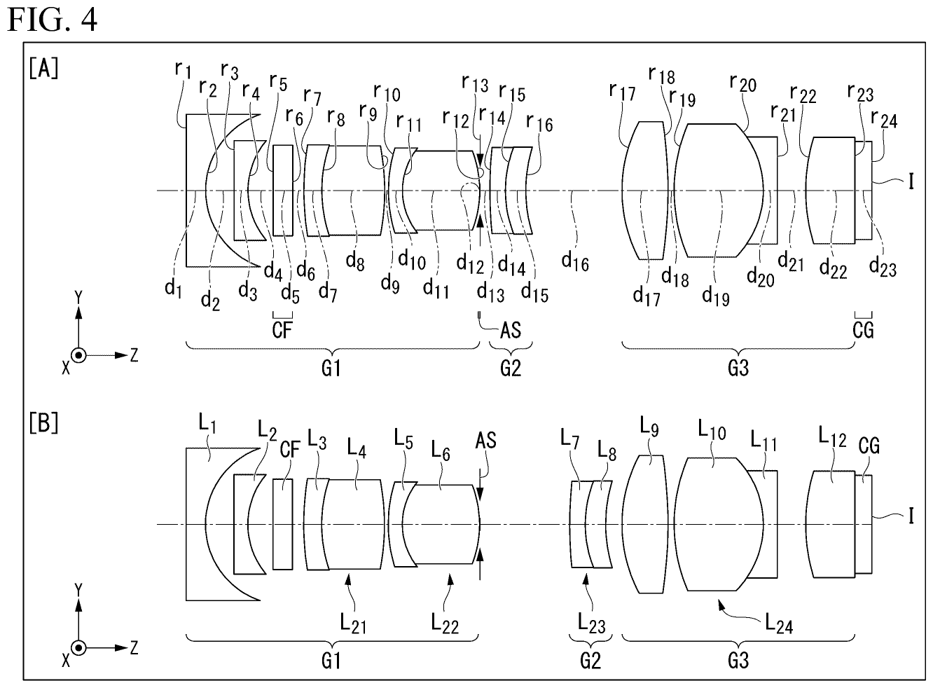

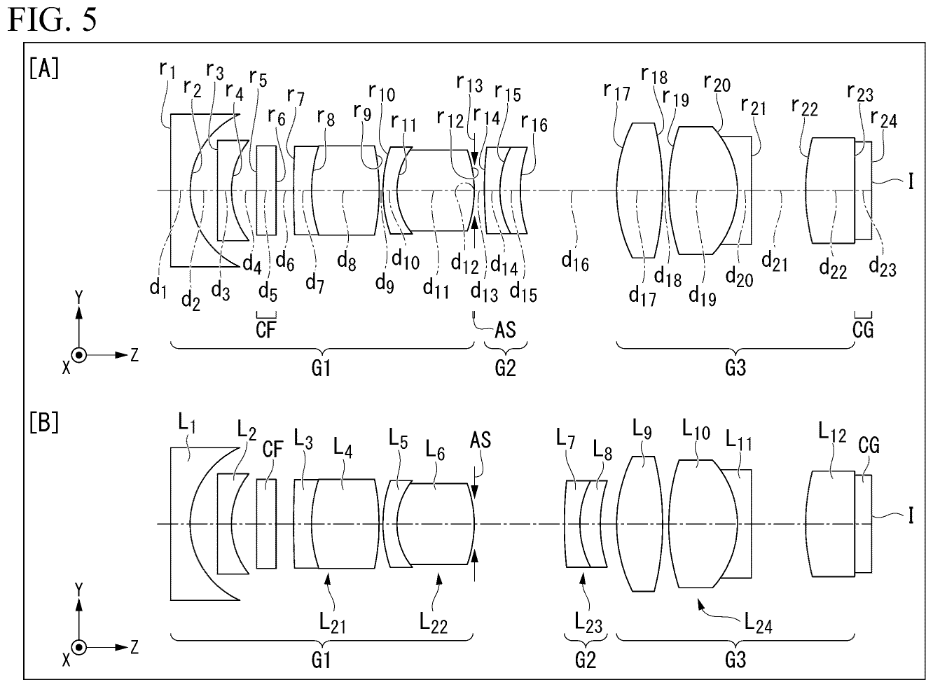

Each of FIGS. 1 to 5 is a cross-sectional view of an objective optical system of one of Example 1 to Example 5. In each of FIGS. 1 to 5, [A] is a cross-sectional view when focusing on a far object point, that is, during magnified observation, and [B] is a cross-sectional view when focusing on a near object point, that is, during normal observation.

In each of FIGS. 1 to 5, in the objective optical system of each example, a first lens group is indicated as G1, a second lens group is indicated as G2, a third lens group is indicated as G3, an infrared filter is indicated as CF, an aperture stop is indicated as AS, a cover glass is indicated as CG, and an image surface, that is, an imaging surface, is indicated as I.

As shown in each of FIGS. 1 to 5, the objective optical system of each of Examples 1 to 5 includes, in order from the object side, the first lens group G1 having a positive refractive power, the second lens group G2 having a negative refractive power, and the third lens group G3 having a positive refractive power. The objective optical system of each of Examples 1 to 5 has the configurations and the relative arrangements of the various lenses described above. In the objective optical system of each of Examples 1 to 5, conditional expressions (1) to (11) are mutually and simultaneously satisfied.

In the objective optical system of each of Examples 1 to 5, when focusing on a far object point to a near object point, the second lens group G2 moves from the object side to the image side on the optical axis, and the first lens group G1 and the third lens group G3 are fixed on the optical axis. At this time, the infrared filter CF and the aperture stop AS are fixed on the optical axis, similarly to the first lens group G1. The cover glass CG is fixed on the optical axis, similar to the third lens group G3.

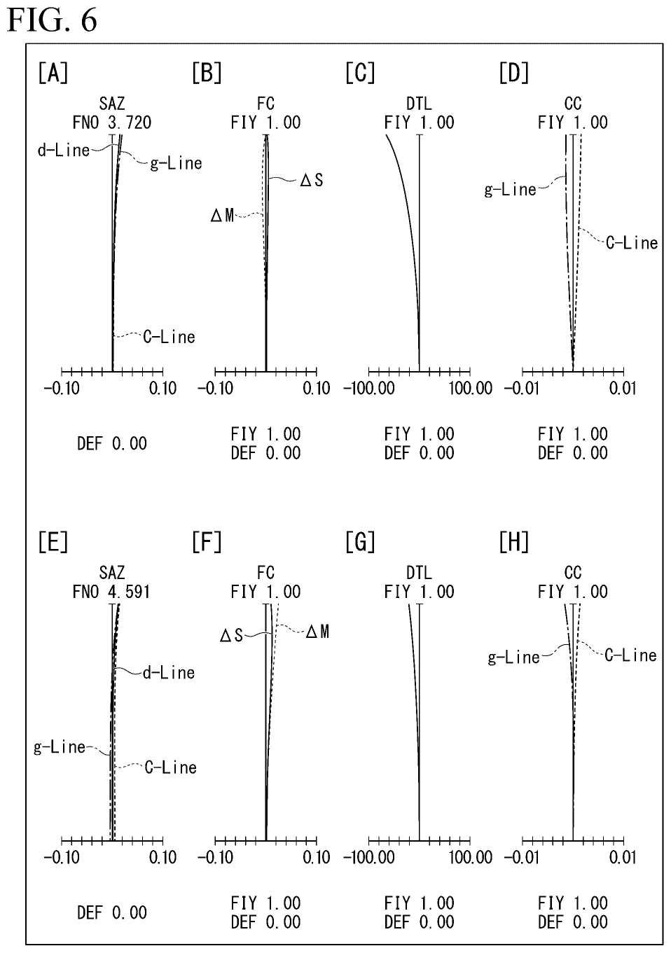

Each of FIGS. 6 to 10 is an aberration diagram of the objective optical system of one of Example 1 to Example 5. In each of FIGS. 6 to 10, [A], [B], [C], and [D] are aberration diagrams when focusing on the far object point, that is, during the normal observation, and [E], [F], [G], and [H] are aberration diagrams aberration diagrams when focusing on the near object point, that is, during the magnified observation. In each of in FIGS. 6 to 10, [A] and [E] are diagrams of spherical aberration (SA). [B] and [F] are diagrams of astigmatism (AS). [C] and [G] are diagrams of distortion (DT). [D] and [H] are diagrams of lateral chromatic aberration (CC). In each of [A], [D], [E], and [H], the “g-Line” represents each aberration at a wavelength of 435.84 nm, and the “C-Line” represents each aberration at a wavelength of 656.27 nm. In [A] and [E], the “d-Line” represents each aberration at a wavelength of 587.56 nm. In [B] and [F], AM represents the aberration with respect to a meridional image surface at the d-Line, and AS represents the aberration with respect to a sagittal image surface at the d-Line.

The configuration of the objective optical system of each of Examples 1 to 5 will be described below with reference to FIGS. 1 to 5 and TABLES 1 to 20.

### Example 1

As shown in FIG. 1, in the objective optical system of Example 1, the first lens group G1 consists of two plano-concave lenses L₁ and L₂ having a negative refractive power and two cemented lenses L₂₁ and L₂₂ having a positive refractive power, which are disposed in order from the object side. The first lens group G1 as a whole has a positive refractive power.

The plano-concave lens L₁ is one disposed on the object side out of the two negative lenses disposed on the object side in the first lens group G1 of the objective optical system of the present embodiment and corresponds to a “negative lens having a flat surface on the object side and having a concave curved surface, which is concave toward the object side, on the image side.” The plano-concave lens L₂ is one disposed on the image side out of the two negative lenses disposed on the object side in the first lens group of the objective optical system of the present embodiment and corresponds to a “negative lens having a concave curved surface, which is concave toward the object side, on the image side.” The object side surface of each of the plano-concave lenses L₁ and L₂ is a flat surface perpendicular to the optical axis. The image side surface of each of the plano-concave lenses L₁ and L₂ is a concave curved surface that is concave toward the object side.

The cemented lens L₂₁ has a concave meniscus lens L₃ disposed on the object side and a biconvex lens L₄ cemented to the image side of the concave meniscus lens L₃. The concave meniscus lens L₃ corresponds to a “negative lens” disposed on the object side in the cemented lens disposed on the object side out of the two cemented lenses included in the first lens group of the objective optical system of the present embodiment. The object side surface of the concave meniscus lens L₃ is a convex surface that faces the object side, and the image side surface of the concave meniscus lens L₃ is a concave surface that faces the image side. The radius of curvature of the object side surface of the concave meniscus lens L₃ is larger than the radius of curvature of the image side surface of the concave meniscus lens L₃. The biconvex lens L₄ corresponds to a “positive lens” disposed on the image side in the cemented lens disposed on the object side out of the two cemented lenses included in the first lens group of the objective optical system of the present embodiment. The object side surface of the biconvex lens L₄ is a convex curved surface that protrudes toward the object side and overlaps the image side surface of the concave meniscus lens L₃. That is, the cemented surface of the cemented lens L₂₁ is a convex surface that protrudes toward the object side when viewed from the object side. The image side surface of the biconvex lens L₄ is a convex curved surface that protrudes toward the image side.

The cemented lens L₂₂ has a concave meniscus lens L₅ disposed on the image side and a biconvex lens L₆ cemented to the image side of the concave meniscus lens L₅. The concave meniscus lens L₅ corresponds to a “negative lens” disposed on the object side in the cemented lens disposed on the image side out of the two cemented lenses included in the first lens group of the objective optical system of the present embodiment. The object side surface of the concave meniscus lens L₅ is a convex surface that faces the object side, and the image side surface of the concave meniscus lens L₅ is a concave surface that faces the image side. The radius of curvature of the object side surface of the concave meniscus lens L₅ is larger than the radius of curvature of the image side surface of the concave meniscus lens L₅. The biconvex lens L₆ corresponds to a “positive lens” disposed on the image side in the cemented lens disposed on the image side out of the two cemented lenses included in the first lens group of the objective optical system of the present embodiment. The object side surface of the biconvex lens L₆ is a convex curved surface that protrudes toward the object side and overlaps the image side surface of the concave meniscus lens L₅. That is, the cemented surface of the cemented lens L₂₂ is a convex surface that protrudes toward the object side when viewed from the object side. The image side surface of the biconvex lens L₆ is a convex curved surface that protrudes toward the image side.

The infrared filter CF is disposed on the optical axis between the plano-concave lens L₂ and the cemented lens L₂₁ in the first lens group G1. The object side surface and the image side surface of the infrared filter CF are flat surfaces perpendicular to the optical axis. The aperture stop AS is disposed on the optical axis closer to the image side than the cemented lens L₂₁ of the first lens group G1.

In the objective optical system of Example 1, the second lens group G2 consists of one cemented lens L₂₃ having a negative refractive power. The cemented lens L₂₃ has a concave meniscus lens L₇ disposed on the object side and a convex meniscus lens L₈ cemented to the image side of the concave meniscus lens L₇. The second lens group G2 has a negative refractive power.

The concave meniscus lens L₇ corresponds to a “negative lens” disposed on the object side in the cemented lens that constitutes the second lens group of the objective optical system of the present embodiment. The object side surface of the concave meniscus lens L₇ is a convex surface that faces the object side, and the image side surface of the concave meniscus lens L₇ is a concave surface that faces the image side. The radius of curvature of the object side surface of the concave meniscus lens L₇ is larger than the radius of curvature of the image side surface of the concave meniscus lens L₇. The convex meniscus lens La corresponds to a “positive lens” disposed on the image side in the cemented lens that constitutes the second lens group of the objective optical system of the present embodiment. The object side surface of the convex meniscus lens La is a convex surface that faces the object side and overlaps the image side surface of the concave meniscus lens L₇. That is, the cemented surface of the cemented lens L₂₃ is a convex surface that protrudes toward the object side when viewed from the object side. The image side surface of the convex meniscus lens La is concave surface that faces the image side. The radius of curvature of the object side surface of the convex meniscus lens L₈ is smaller than the radius of curvature of the image side surface of the convex meniscus lens L₈.

In the objective optical system of Example 1, the third lens group G3 consists of a biconvex lens L₉ having a positive refractive power, a cemented lens L₂₄ having a positive refractive power, and a plano-convex lens L₁₂ having a positive refractive power, which are disposed in order from the object side. The third lens group G3 as a whole has a positive refractive power.

The biconvex lens L₉ is a single lens having a positive refractive power and corresponds to “one biconvex single lens” included in the third lens group of the objective optical system of the present embodiment. The object side surface of the biconvex lens L₉ is a convex curved surface that protrudes toward the object side. The image side surface of the biconvex lens L₉ is a convex curved surface that protrudes toward the image side. The radius of curvature of the object side surface of the biconvex lens L₉ is smaller than the radius of curvature of the image side surface of the biconvex lens L₉.

The cemented lens L₂₄ has a biconvex lens L₁₀ disposed on the image side and a plano-concave lens L₁₁ cemented to the image side of the biconvex lens L₁₀. The object side surface of the biconvex lens L₁₀ is a convex curved surface that protrudes toward the object side. The image side surface of the biconvex lens L₁₀ is a convex curved surface that protrudes toward the image side. The object side surface of the plano-concave lens L₁₁ is a concave curved surface that is concave toward the image side and overlaps the image side surface of the biconvex lens L₁₀. That is, the cemented surface of the cemented lens L₂₄ is a concave curved surface that is concave toward the image side. The image side surface of the plano-concave lens Ln is a flat surface perpendicular to the optical axis.

The plano-convex lens L₁₂ is a lens having a positive refractive power and corresponds to a “lens with a positive refractive power” included in the third lens group of the objective optical system of the present embodiment and cemented to a surface of an incidence side of the cover glass. The object side surface of the plano-convex lens L₁₂ is a convex curved surface that protrudes toward the object side. The image side surface of the plano-convex lens L₁₂ is a flat surface perpendicular to the optical axis.

The cover glass CG is disposed on the optical axis on the image side of the plano-convex lens L₁₂ in the first lens group G3. The object side surface and the image side surface of the cover glass CG are flat surfaces perpendicular to the optical axis. As described above, the object side surface of the cover glass CG is in contact with the image side surface of the plano-convex lens L₁₂.

The numerical data of the objective optical system of Example 1 are will be shown below. In the surface data of the numerical data in each of Examples 1 to 5, the numerical value in the “Curvature radius” column represents the radius of curvature of each surface. The numerical value in the “Thickness” column represents the spacing between the surfaces. The numerical value in the “Index” column represents the refractive index of each lens at a wavelength of 587.56 nm, that is, at the d-Line. The numerical value in the “Abbe #” column represents the Abbe number of each lens. The unit of each numerical value with respect to length is millimeters [mm]. AS represents the aperture stop.

TABLE 1

| Surface # | Curvature radius | Thickness | Index | Abbe # |
|---|---|---|---|---|
| 1 | ∞ | 0.4902 | 1.88300 | 40.76 |
| 2 | 2.120 | 0.7145 | | |
| 3 | ∞ | 0.3529 | 1.88300 | 40.76 |
| 4 | 1.868 | 0.5265 | | |
| 5 | ∞ | 0.4902 | 1.49400 | 75.01 |
| 6 | ∞ | 0.1225 | | |
| 7 | 8.093 | 0.4534 | 1.84666 | 23.78 |
| 8 | 3.507 | 1.9107 | 1.62004 | 36.26 |
| 9 | −5.886 | 0.0975 | | |
| 10 | 3.333 | 0.3529 | 1.80610 | 40.92 |
| 11 | 1.708 | 1.9429 | 1.49700 | 81.54 |
| 12 | −2.891 | 0.0110 | | |
| 13 | AS | D13 | | |
| 14 | 8.584 | 0.3922 | 1.88300 | 40.76 |
| 15 | 2.637 | 0.5147 | 1.95906 | 17.47 |
| 16 | 3.373 | D16 | | |
| 17 | 3.540 | 1.1581 | 1.65160 | 58.55 |
| 18 | −27.048 | 0.1544 | | |
| 19 | 3.535 | 2.2441 | 1.49700 | 81.54 |
| 20 | −2.379 | 0.3529 | 1.95906 | 17.47 |
| 21 | ∞ | 0.6287 | | |
| 22 | 4.686 | 1.2377 | 1.51633 | 64.14 |
| 23 | ∞ | 0.4289 | 1.50510 | 63.26 |
| 24 | ∞ | 0.0000 | | |

TABLE 2

| | Far object point | Near object point |
|---|---|---|
| Object length | 22.059 | 2.451 |
| Focal length | 1.0354 | 1.2787 |
| F-number | 3.720 | 4.591 |
| Angle of view (2 ω) | 142.59 | 93.37 |
| Image height | 1.000 | 1.000 |
| Total length | 17.262 | 17.262 |
| Thickness of #13 (D13) | 0.2451 | 2.2739 |
| Thickness of #16 (D16) | 2.4398 | 0.4106 |

TABLE 3
Focal length

| | |
|---|---|
| First lens group | 2.6056 |
| Second lens group | −7.2816 |
| Third lens group | 3.6959 |

TABLE 4

| | | |
|---|---|---|
| Conditional expression (1) | Fno | 3.72 |
| Conditional expression (2) | flr/fc12 | 2.77 |
| Conditional expression (3) | fc1/fc2 | 1.56 |
| Conditional expression (4) | fc1n/fc2n | 1.59 |
| Conditional expression (5) | fc1p/fc2p | 1.53 |
| Conditional expression (6) | fc1n/fc12 | −2.34 |
| Conditional expression (7) | d1a/dc1a | 1.57 |
| Conditional expression (8) | fc12/fw | 3.16 |
| Conditional expression (9) | fc12/f1 | 1.26 |
| Conditional expression (10) | f2/fc12 | −2.23 |
| Conditional expression (11) | flp/fc12 | 1.49 |

As can be seen from FIG. 6, in the objective optical system of Example 1, for example, the spherical aberration, the astigmatism, the distortion, and the lateral chromatic aberration among the various aberrations are corrected, and favorable aberration characteristics are obtained in the visible wavelength region.

### Example 2

In each of the examples including Example 2, which will be described below, lenses and optical components of the same types as those in the previously described example are given the same reference signs as the corresponding lenses and optical components in the previously described example. In each of the examples including

Example 2, which will be described below, explanations common to the lenses and optical components of the previously described example will be omitted, and only the contents of the objective optical system of each example that are different from those of the objective optical system of Example 1 will be explained.

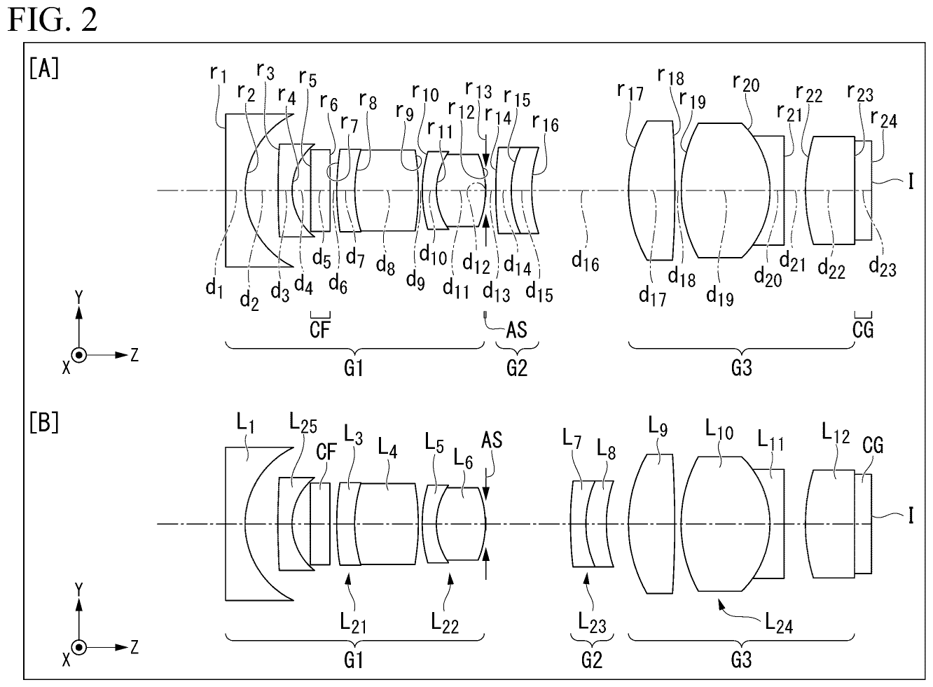

As shown in FIG. 2, in the objective optical system of Example 2, the first lens group G1 consists of a plano-concave lens L₁ having a negative refractive power, a concave meniscus lens L₂₅ having a negative refractive power, and two cemented lenses L₂₁ and L₂₂ having a positive refractive power, which are disposed in order from the object side. The first lens group G1 as a whole has a positive refractive power.

The concave meniscus lens L₂₅ is one disposed on the image side out of the two negative lenses disposed on the object side in the first lens group of the objective optical system of the present embodiment and corresponds to a “negative lens having a concave curved surface, which is concave toward the object side, on the image side.” The object side surface of the concave meniscus lens L₂₅ is a convex surface that faces the object side, and the image side surface of the concave meniscus lens L₂₅ is a concave surface that faces the image side. The radius of curvature of the object side surface of the concave meniscus lens L₂₅ is larger than the radius of curvature of the image side surface of the concave meniscus lens L₂₅.

The configurations of the second lens group G2 and the third lens group G3 in the objective optical system of Example 2 are common to the configurations of the second lens group G2 and the third lens group G3 in the objective optical system of Example 1.

The numerical data of the objective optical system of Example 2 are will be shown below.

TABLE 5

| Surface # | Curvature radius | Thickness | Index | Abbe # |
|---|---|---|---|---|
| 1 | ∞ | 0.4902 | 1.88300 | 40.76 |
| 2 | 2.133 | 0.8273 | | |
| 3 | 19.514 | 0.3554 | 1.88300 | 40.76 |
| 4 | 1.486 | 0.4657 | | |
| 5 | ∞ | 0.4902 | 1.53962 | 66.83 |
| 6 | ∞ | 0.1716 | | |
| 7 | 6.787 | 0.4534 | 1.84666 | 23.78 |
| 8 | 3.507 | 1.6023 | 1.62004 | 36.26 |
| 9 | −6.271 | 0.0981 | | |
| 10 | 3.508 | 0.3554 | 1.80610 | 40.93 |
| 11 | 1.708 | 1.2339 | 1.49700 | 81.54 |
| 12 | −2.388 | 0.0130 | | |
| 13 | AS | D13 | | |
| 14 | 8.584 | 0.3906 | 1.88300 | 40.76 |
| 15 | 2.637 | 0.5147 | 1.95906 | 17.47 |
| 16 | 3.373 | D16 | | |
| 17 | 3.540 | 1.1642 | 1.65160 | 58.55 |
| 18 | −27.048 | 0.1594 | | |
| 19 | 3.535 | 2.2388 | 1.49700 | 81.54 |
| 20 | −2.379 | 0.3554 | 1.95906 | 17.47 |
| 21 | ∞ | 0.5393 | | |
| 22 | 4.686 | 1.2377 | 1.51633 | 64.14 |
| 23 | ∞ | 0.4289 | 1.51000 | 62.00 |
| 24 | ∞ | 0.0023 | | |

TABLE 6

| | Far object point | Near object point |
|---|---|---|
| Object length | 25.123 | 2.353 |
| Focal length | 1.0227 | 1.2404 |
| F-number | 3.685 | 4.466 |
| Angle of view (2ω) | 147.28 | 97.74 |
| Image height | 1.000 | 1.000 |
| Total length | 16.275 | 16.278 |
| Thickness of #13 (D13) | 0.2451 | 2.1289 |
| Thickness of #16 (D16) | 2.4415 | 0.5576 |

TABLE 7
Focal length

| | |
|---|---|
| First lens group | 2.5055 |
| Second lens group | −7.2805 |
| Third lens group | 3.6655 |

TABLE 8

| | | |
|---|---|---|
| Conditional expression(1) | Fno | 3.69 |
| Conditional expression(2) | flr/fc12 | 3.12 |
| Conditional expression(3) | fc1/fc2 | 1.62 |
| Conditional expression(4) | fc1n/fc2n | 2.02 |
| Conditional expression(5) | f1p/fc2p | 1.74 |
| Conditional expression(6) | fc1n/fc12 | −3.14 |
| Conditional expression(7) | d1a/dc1a | 1.75 |
| Conditional expression(8) | fc12/fw | 2.85 |
| Conditional expression(9) | fc12/f1 | 1.16 |
| Conditional expression(10) | f2/fc12 | −2.50 |
| Conditional expression(11) | flp/fc12 | 1.68 |

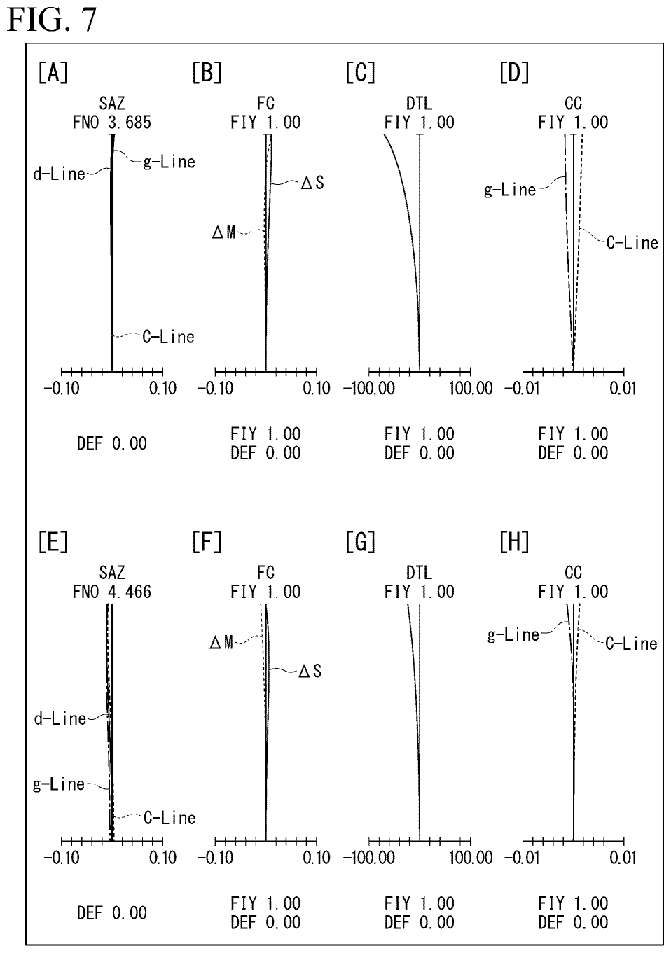

As can be seen from FIG. 7, in the objective optical system of Example 2, for example, the spherical aberration, the astigmatism, the distortion, and the lateral chromatic aberration among the various aberrations are corrected, and favorable aberration characteristics are obtained in the visible wavelength region.

### Example 3

The configurations of the first lens group G1, the second lens group G2, and the third lens group G3 in the objective optical system of Example 3 are common to the configurations of the first lens group G1, the second lens group G2, and the third lens group G3 in the objective optical system of Example 1.

The numerical data of the objective optical system of Example 3 are will be shown below.

TABLE 9

| Surface # | Curvature radius | Thickness | Index | Abbe # |
|---|---|---|---|---|
| 1 | ∞ | 0.4902 | 1.88300 | 40.76 |
| 2 | 2.022 | 0.7145 | | |
| 3 | ∞ | 0.3529 | 1.88300 | 40.76 |
| 4 | 1.926 | 0.6351 | | |
| 5 | ∞ | 0.4902 | 1.49400 | 75.01 |
| 6 | ∞ | 0.0140 | | |
| 7 | 6.405 | 0.4534 | 1.84666 | 23.78 |
| 8 | 3.527 | 1.9650 | 1.62004 | 36.26 |
| 9 | −5.989 | 0.0973 | | |
| 10 | 3.589 | 0.3529 | 1.80610 | 40.92 |
| 11 | 1.708 | 1.9429 | 1.49700 | 81.54 |
| 12 | −2.793 | 0.0110 | | |
| 13 | AS | D13 | | |
| 14 | 10.974 | 0.3922 | 1.88300 | 40.76 |
| 15 | 2.795 | 0.5147 | 1.95906 | 17.47 |
| 16 | 3.685 | D16 | | |
| 17 | 3.623 | 1.1581 | 1.65160 | 58.55 |
| 18 | −13.883 | 0.1544 | | |
| 19 | 4.010 | 2.2369 | 1.49700 | 81.54 |
| 20 | −2.379 | 0.3529 | 1.95906 | 17.47 |
| 21 | ∞ | 0.6598 | | |
| 22 | 4.678 | 1.2377 | 1.51633 | 64.14 |
| 23 | ∞ | 0.4289 | 1.50510 | 63.26 |
| 24 | ∞ | 0.0000 | | |

TABLE 10

| | Far object point | Near object point |
|---|---|---|
| Object length | 22.059 | 2.451 |
| Focal length | 1.0245 | 1.2790 |
| F-number | 3.721 | 4.642 |
| Angle of view (2ω) | 143.42 | 93.11 |
| Image height | 1.000 | 1.000 |
| Total length | 17.338 | 17.342 |
| Thickness of #13 (D13) | 0.2451 | 2.2759 |
| Thickness of #16 (D16) | 2.4374 | 0.4105 |

TABLE 11
Focal length

| | |
|---|---|
| First lens group | 2.5678 |
| Second lens group | −7.0739 |
| Third lens group | 3.6834 |

TABLE 12

| | | |
|---|---|---|
| Conditional expression(1) | Fno | 3.72 |
| Conditional expression(2) | flr/fc12 | 2.76 |
| Conditional expression(3) | fc1/fc2 | 1.30 |
| Conditional expression(4) | fc1n/fc2n | 2.28 |
| Conditional expression(5) | fc1p/fc2p | 1.56 |
| Conditional expression(6) | fc1n/fc12 | −3.04 |
| Conditional expression(7) | d1a/dc1a | 1.56 |
| Conditional expression(8) | fc12/fw | 3.21 |
| Conditional expression(9) | fc12/f1 | 1.28 |
| Conditional expression(10) | f2/fc12 | −2.15 |
| Conditional expression(11) | flp/fc12 | 1.38 |

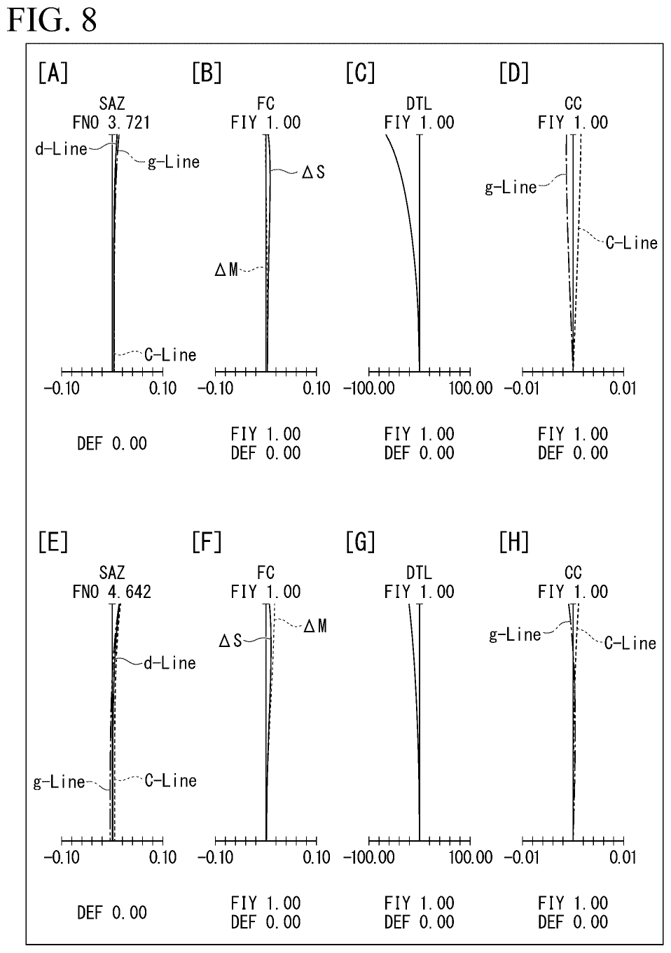

As can be seen from FIG. 8, in the objective optical system of Example 3, for example, the spherical aberration, the astigmatism, the distortion, and the lateral chromatic aberration among the various aberrations are corrected, and favorable aberration characteristics are obtained in the visible wavelength region.

### Example 4

The configurations of the first lens group G1, the second lens group G2, and the third lens group G3 in the objective optical system of Example 4 are common to the configurations of the first lens group G1, the second lens group G2, and the third lens group G3 in the objective optical system of Example 1.

The numerical data of the objective optical system of Example 4 are will be shown below.

TABLE 13

| Surface # | Curvature radius | Thickness | Index | Abbe # |
|---|---|---|---|---|
| 1 | ∞ | 0.4902 | 1.88300 | 40.76 |
| 2 | 2.029 | 0.7145 | | |
| 3 | ∞ | 0.3529 | 1.88300 | 40.76 |
| 4 | 1.926 | 0.6351 | | |
| 5 | ∞ | 0.4902 | 1.49400 | 75.01 |
| 6 | ∞ | 0.2794 | | |
| 7 | 7.016 | 0.4534 | 1.84666 | 23.78 |
| 8 | 3.543 | 1.5805 | 1.62004 | 36.26 |
| 9 | −6.036 | 0.0973 | | |
| 10 | 3.623 | 0.3529 | 1.80610 | 40.92 |
| 11 | 1.700 | 1.9429 | 1.49700 | 81.54 |
| 12 | −2.791 | 0.0110 | | |
| 13 | AS | D13 | | |
| 14 | 11.057 | 0.3922 | 1.88300 | 40.76 |
| 15 | 2.943 | 0.5147 | 1.95906 | 17.47 |
| 16 | 3.701 | D16 | | |
| 17 | 3.722 | 1.1581 | 1.65160 | 58.55 |
| 18 | −11.486 | 0.1544 | | |
| 19 | 4.221 | 2.2456 | 1.49700 | 81.54 |
| 20 | −2.379 | 0.3529 | 1.95906 | 17.47 |
| 21 | ∞ | 0.7147 | | |
| 22 | 4.564 | 1.2377 | 1.51633 | 64.14 |
| 23 | ∞ | 0.4289 | 1.50510 | 63.26 |
| 24 | ∞ | 0.0000 | | |

TABLE 14

| | Far object point | Near object point |
|---|---|---|
| Object length | 22.059 | 2.451 |
| Focal length | 1.0164 | 1.2724 |
| F-number | 3.720 | 4.654 |
| Angle of view (2ω) | 143.77 | 93.50 |
| Image height | 1.000 | 1.000 |
| Total length | 17.267 | 17.271 |
| Thickness of #13 (D13) | 0.2451 | 2.2608 |
| Thickness of #16 (D16) | 2.4217 | 0.4105 |

TABLE 15
Focal length

| | |
|---|---|
| First lens group | 2.5408 |
| Second lens group | −7.0230 |
| Third lens group | 3.7132 |

TABLE 16

| | | |
|---|---|---|
| Conditional expression(1) | Fno | 3.72 |
| Conditional expression(2) | flr/fc12 | 2.67 |
| Conditional expression(3) | fc1/fc2 | 1.36 |
| Conditional expression(4) | fc1n/fc2n | 2.08 |
| Conditional expression(5) | fc1p/fc2p | 1.55 |
| Conditional expression(6) | fc1n/fc12 | −2.72 |
| Conditional expression(7) | d1a/dc1a | 1.67 |
| Conditional expression(8) | fc12/fw | 3.25 |
| Conditional expression(9) | fc12/f1 | 1.30 |
| Conditional expression(10) | f2/fc12 | −2.13 |
| Conditional expression(11) | flp/fc12 | 1.35 |

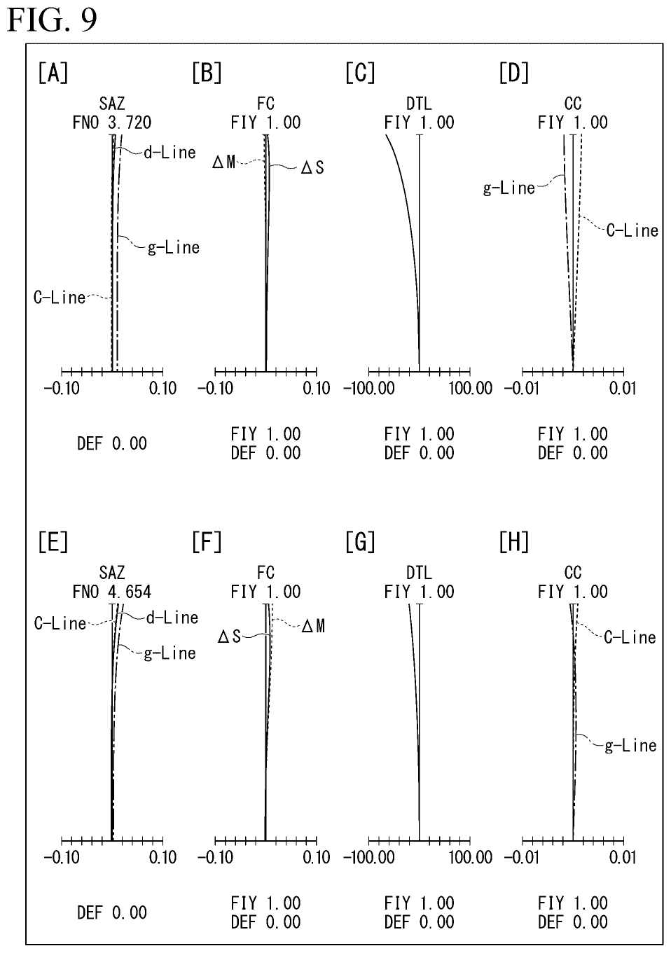

As can be seen from FIG. 9, in the objective optical system of Example 4, for example, the spherical aberration, the astigmatism, the distortion, and the lateral chromatic aberration among the various aberrations are corrected, and favorable aberration characteristics are obtained in the visible wavelength region.

### Example 5

The configurations of the first lens group G1, the second lens group G2, and the third lens group G3 in the objective optical system of Example 5 are common to the configurations of the first lens group G1, the second lens group G2, and the third lens group G3 in the objective optical system of Example 1.

The numerical data of the objective optical system of Example 5 are will be shown below.

TABLE 17

| Surface # | Curvature radius | Thickness | Index | Abbe # |
|---|---|---|---|---|
| 1 | ∞ | 0.4902 | 1.88300 | 40.76 |
| 2 | 2.103 | 0.6894 | | |
| 3 | ∞ | 0.3529 | 1.88300 | 40.76 |
| 4 | 2.028 | 0.6351 | | |
| 5 | ∞ | 0.4902 | 1.49400 | 75.01 |
| 6 | ∞ | 0.4424 | | |
| 7 | 25.117 | 0.4534 | 1.84666 | 23.78 |
| 8 | 3.581 | 1.7013 | 1.62004 | 36.26 |
| 9 | −5.496 | 0.0973 | | |
| 10 | 3.309 | 0.3529 | 1.80610 | 40.92 |
| 11 | 1.745 | 1.9429 | 1.49700 | 81.54 |
| 12 | −3.078 | 0.0110 | | |
| 13 | AS | D13 | | |
| 14 | 10.524 | 0.3922 | 1.88300 | 40.76 |
| 15 | 2.336 | 0.5147 | 1.95906 | 17.47 |
| 16 | 3.539 | D16 | | |
| 17 | 3.816 | 1.1581 | 1.65160 | 58.55 |
| 18 | −6.989 | 0.1544 | | |
| 19 | 5.154 | 1.7288 | 1.49700 | 81.54 |
| 20 | −2.379 | 0.3529 | 1.95906 | 17.47 |
| 21 | ∞ | 1.3670 | | |
| 22 | 5.250 | 1.2377 | 1.51633 | 64.14 |
| 23 | ∞ | 0.4289 | 1.50510 | 63.26 |
| 24 | ∞ | 0.0000 | | |

TABLE 18

| | Far object point | Near object point |
|---|---|---|
| Object length | 22.059 | 2.451 |
| Focal length | 1.0042 | 1.2680 |
| F-number | 3.715 | 4.689 |
| Angle of view (2ω) | 143.52 | 93.84 |
| Image height | 1.000 | 1.000 |
| Total length | 17.663 | 17.665 |
| Thickness of #13 (D13) | 0.2451 | 2.2604 |
| Thickness of #16 (D16) | 2.4240 | 0.4105 |

TABLE 19
Focal length

| | |
|---|---|
| First lens group | 2.4837 |
| Second lens group | −7.0355 |
| Third lens group | 3.9537 |

TABLE 20

| | | |
|---|---|---|
| Conditional expression(1) | Fno | 3.72 |
| Conditional expression(2) | flr/fc12 | 2.89 |
| Conditional expression(3) | fc1/fc2 | 2.47 |
| Conditional expression(4) | fc1n/fc2n | 0.98 |
| Conditional expression(5) | fc1p/fc2p | 1.46 |
| Conditional expression(6) | fc1n/fc12 | −1.41 |
| Conditional expression(7) | d1a/dc1a | 1.68 |
| Conditional expression(8) | fc12/fw | 3.51 |
| Conditional expression(9) | fc12/f1 | 1.42 |
| Conditional expression(10) | f2/fc12 | −2.00 |
| Conditional expression(11) | flp/fc12 | 1.12 |

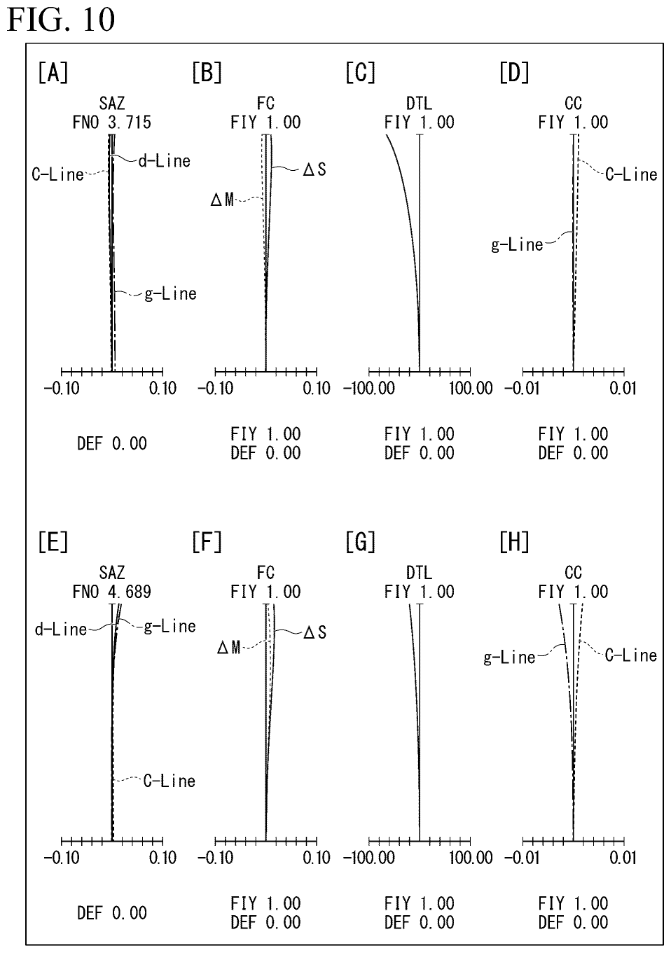

As can be seen from FIG. 10, in the objective optical system of Example 5, for example, the spherical aberration, the astigmatism, the distortion, and the lateral chromatic aberration among the various aberrations are corrected, and favorable aberration characteristics are obtained in the visible wavelength region.

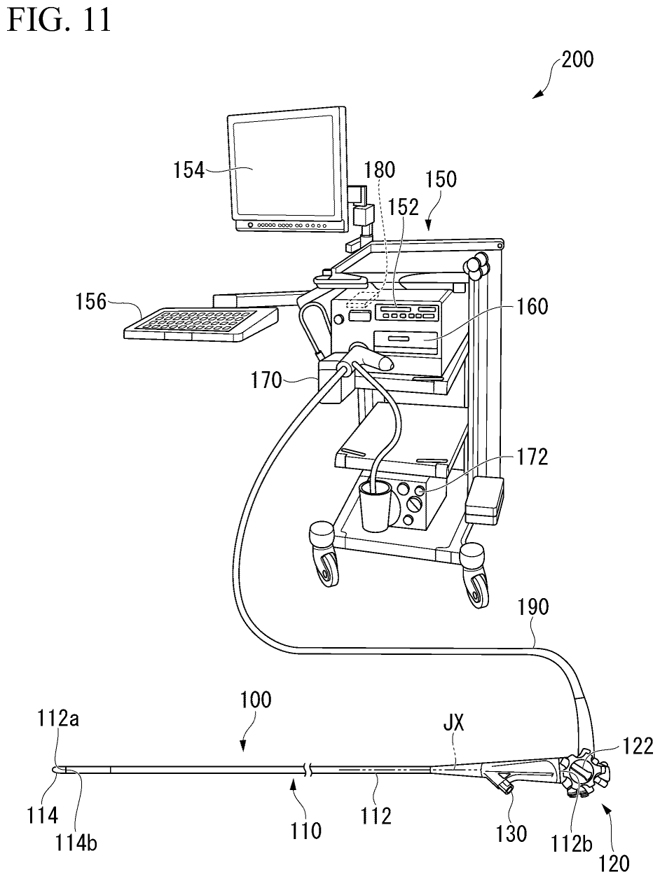

Next, the endoscope of the present embodiment will be described with reference to FIG. 11. FIG. 11 is a schematic diagram of an endoscope 100 according to the present embodiment.

As shown in FIG. 11, the endoscope 100 includes an insertion section 110 and an operation section 120. The insertion section 110 is elongated and formed to be insertable into a body cavity of a subject (not shown). The insertion section 110 has an extension portion 112 and a distal end portion 114. The extension portion 112 can be freely bent along an axis JX by the operation of the user using the operation section 120. The axial shape of the extension portion 112 along the axis JX can be freely changed along the anatomical passage, into which the extension portion 12 is inserted, such as the stomach, the duodenum, the kidney, the ureter, and the like of the subject. The extension portion 112 is formed of a flexible material. The distal end portion 114 is disposed at a distal end 112a of the extension portion 112, has approximately the same diameter as the extension portion 112, and is inserted integrally with the extension portion 112 into the anatomical passage. The distal end 112a of the extension portion 112 is connected to a proximal end 114b of the distal end portion 114.

The insertion section 110 includes, for example, a plurality of extremely elongated accessory members, such as a treatment instrument such as a cholangioscope which are not shown, a light guide cable, an electrical cable, a fluid passage, a guide wire, a pull wire, and the like, and a covering member that covers these accessory members from the outer periphery thereof in the radial direction of the axis JX. The objective optical system of the present embodiment, which includes the infrared filter and the aperture stop, the imaging element having the cover glass, and the supporting member such as the lens barrel are covered with the covering member and housed in the distal end portion 114 of the insertion section 110. The imaging element is, for example, an image sensor such as a complementary metal-oxide semiconductor (CMOS) or a charge coupled device (CCD).

The operation section 120 is connected to a proximal end 112b of the extension portion 112 of the insertion section 110. The operation section 120 is connected to the proximal end 112b that is opposite to the distal end 112a that is connected to the distal end portion 114 in the extension portion 112. The operation section 120 includes a control knob 122 and a port 130. The control knob 122 is used by the user to manually advance and retract the insertion section 110, to change the axial shape of the extension portion 112 to curve it, or to change a direction in which the distal end portion 114 faces. The port 130 is configured to allow accessory members, such as various types of electric cables, a guide wire, an auxiliary scope, and a fluid tube, to be attached to the operation section 120 for connection to the insertion section 110.

The endoscope 100 of the present embodiment is connected to an imaging device 200. The imaging device 200 includes a control device 150. The control device 150 includes, for example, a controller 152, an output device 154, an input device 156, a light source 160, a fluid source 170, and a suction pump 172. The controller 152 receives data relating to the object to be observed from the endoscope 100 and transmits data to the endoscope 100, and includes an image processing device 180. The operation section 120 of the endoscope 100 is connected to the controller 152 via a connection section 190 constituted by a universal cord or the like. The image processing device 180 receives, via the connection section 190, information about the image acquired by the objective optical system of the present embodiment, that is, the image formed on the image surface I of the objective optical system. The image processing device 180 processes the received image, converts the image into an electrical signal, and transmits the signal to the output device 154.

The output device 154 outputs a plurality of pieces of information including information about the image of the object to be observed that is transmitted from the imaging element 180 or the object to be observed, information received from the controller 152, and information about the operation of the endoscope 100. The output device 154 is, for example, a display capable of displaying the plurality of pieces of information received as described above. The input device 156 mainly inputs a plurality of pieces of information including information about the operation of the endoscope 100 or the subject to the controller 152. The input device 156 is, for example, a keyboard, and may also be a mouse, an electronic pen, or the like.

The light source 160 emits light for acquiring the image of the object to be observed. The light emitted from the light source 160 is applied from the distal end portion 114 toward the object to be observed via a fiber link, a light guide cable inserted into the connection section 190, the operation section 120, and the insertion section 110 of the endoscope 100, and the like. The fluid source 170 is configured to be able to communicate with the controller 152 and supplies air or liquids such as treatment water to the endoscope 100 via the port 130. The suction pump 172 discharges a fluid from the anatomical region into which the insertion section 110 of the endoscope 100 is inserted and has a port for generating vacuum suction, for example.

The endoscope 100 of the present embodiment described above includes the objective optical system of the present embodiment. For this reason, according to the endoscope 100 of the present embodiment, the distal end portion 114 of the endoscope 100 is miniaturized and the diameter of the extension portion 112 is reduced, and the object to be observed such as the diseased area can be observed at high resolution using the high-performance objective optical system, and a high-definition image of the object to be observed can be acquired using the imaging element.

The endoscope 100 described above is an example of the endoscope of the present embodiment. Therefore, the configuration of the endoscope of the present embodiment may be changed as appropriate from the configuration of the endoscope 100. For example, the operation section 120 of the endoscope 100 may house a power supply, a light source, an imaging element, and various supply devices (not shown). In addition, in the imaging device 200, for example, the fluid source 170 and the suction pump 172 may be omitted, a videoscope (not shown) may be provided, and a storage device or communication terminal (not shown) may be connected via a wired or wireless connection.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. An endoscope that has an objective optical system for an endoscope, comprising:
an objective optical system for an endoscope; and
an imaging element disposed on an image side of the objective optical system for an endoscope,
wherein the objective optical system for an endoscope consists of
a first lens group with a positive refractive power,
a second lens group with a negative refractive power, and
a third lens group with a positive refractive power, which are disposed in order from an object side to the image side,
wherein during focusing and magnification changing operations, the second lens group moves along an optical axis, and
wherein the first lens group includes
a negative lens that has a flat surface on the object side and of which an image side surface is a concave surface that faces the image side,
a negative lens of which an image side surface is a concave surface that faces the image side,
a cemented lens that consists of, in order from the object side, a negative lens and a positive lens, and has a cemented surface forming a convex curved surface protruding toward the object side, and
a cemented lens that consists of, in order from the object side, a negative lens and a positive lens, and has a cemented surface forming a convex curved surface protruding toward the object side, which are disposed in order from the object side to the image side.

2. The endoscope that has an objective optical system for an endoscope according to claim 1,
wherein the objective optical system for an endoscope satisfies the following conditional expression (1):
$$Fno < 4.0 \qquad ( 1 )$$
where, in Expression (1),
Fno: an F-number of the objective optical system for an endoscope when focusing on a far object point.

3. The endoscope that has an objective optical system for an endoscope according to claim 1, further comprising a cover glass disposed on an incidence side of the imaging element,
wherein the third lens group has a lens with a positive refractive power cemented to an incidence side of the cover glass, and
wherein the objective optical system for an endoscope satisfies the following conditional expression (2):
$$1. 0 < flr / fc 12 < 5. \qquad ( 2 )$$
where,
flr: a focal length of the lens with a positive refractive power cemented to the incidence side of the cover glass
fc12: a composite focal length of the two cemented lenses in the first lens group.

4. The endoscope that has an objective optical system for an endoscope according to claim 1,
wherein the objective optical system for an endoscope satisfies the following conditional expression (3):
$$1. 0 < fc 1 / fc 2 < 3. \qquad ( 3 )$$
where,
fc1: a focal length of the cemented lens disposed on the object side out of the two cemented lenses in the first lens group
fc2: a focal length of the cemented lens disposed on the image side out of the two cemented lenses in the first lens group.

5. The endoscope that has an objective optical system for an endoscope according to claim 1,
wherein the objective optical system for an endoscope satisfies the following conditional expressions (4) and (5):
$$1. < fc 1 n / fc 2 n < 3. \qquad ( 4 )$$
$$1. < fc 1 p / fc 2 p < 3. \qquad ( 5 )$$
where,
fc1n: a focal length of the negative lens of the cemented lens disposed on the object side out of the two cemented lenses in the first lens group
fc2n: a focal length of the negative lens of the cemented lens disposed on the image side out of the two cemented lenses in the first lens group
fc1p: a focal length of the positive lens of the cemented lens disposed on the object side out of the two cemented lenses in the first lens group
fc2p: a focal length of the positive lens of the cemented lens disposed on the image side out of the two cemented lenses in the first lens group.

6. The endoscope that has an objective optical system for an endoscope according to claim 1,
wherein the objective optical system for an endoscope satisfies the following conditional expression (6):
$$- 5. < fc 1 n / fc 12 < - 1. \qquad ( 6 )$$
where,
fc1n: a focal length of the negative lens of the cemented lens disposed on the object side out of the two cemented lenses in the first lens group
fc12: a composite focal length of the two cemented lenses in the first lens group.

7. The endoscope that has an objective optical system for an endoscope according to claim 1,
wherein the objective optical system for an endoscope has an aperture stop that is disposed on a most image surface side of the first lens group and restricts axial light flux,
wherein during the focusing and magnification changing operations, a position of the first lens group is fixed, and
wherein the objective optical system for an endoscope satisfies the following conditional expression (7):
$$1. 0 < d 1 a / dc 1 a < 3. \qquad ( 7 )$$
where,
d1a: a distance from a most object side surface of the first lens group to the aperture stop
dc1a: a distance from an object side surface of the cemented lens disposed on the object side out of the two cemented lenses in the first lens group to the aperture stop.

8. The endoscope that has an objective optical system for an endoscope according to claim 1,
wherein the objective optical system for an endoscope satisfies the following conditional expression (8):
$$2. < fc 12 / fw < 5. \qquad ( 8 )$$
where,
fc12: a composite focal length of the two cemented lenses in the first lens group
fw: a focal length of the entire objective optical system for an endoscope when focusing on a far object point.

9. The endoscope that has an objective optical system for an endoscope according to claim 1,
wherein the objective optical system for an endoscope satisfies the following conditional expression (9):
$$0.5 < fc 12 / f 1 < 2. \qquad ( 9 )$$
where,
fc12: a composite focal length of the two cemented lenses in the first lens group
f1: a focal length of the first lens group.

10. The endoscope that has an objective optical system for an endoscope according to claim 1,
wherein the second lens group is constituted by a cemented lens that consists of a negative lens and a positive lens, which are disposed in order from the object side,
wherein an image side surface of the second lens group is a concave curved surface that is concave toward the object side, and
wherein the objective optical system for an endoscope satisfies the following conditional expression (10):
$$- 4.0 < f 2 / fc 12 < - 1. \qquad ( 10 )$$
where,
f2: a focal length of the second lens group
fc12: a composite focal length of the two cemented lenses in the first lens group.

11. The endoscope that has an objective optical system for an endoscope according to claim 1,
wherein the imaging element has a cover glass disposed on an incidence side of the imaging element,
wherein the third lens group includes a positive lens cemented to the cover glass and one biconvex single lens and does not include any other single lens having a positive refractive power, and
wherein the objective optical system for an endoscope satisfies the following conditional expression (11):
$$0.5 < flp / fc 12 < 3. \qquad ( 11 )$$
where,
flp: a focal length of the biconvex single lens in the third lens group
fc12: a composite focal length of the two cemented lenses in the first lens group.
